(19) United States
(12) Patent Application Publication
(10) Pub. No.: US 2026/0008941 A1
(43) Pub. Date: Jan. 8, 2026

(54) ARTICLES COMPRISING CYCLIC OLEFIN, CATALYST, AND SECOND POLYMERIZABLE MATERIAL, METHODS AND COMPOSITIONS

(71) Applicant: 3M INNOVATIVE PROPERTIES COMPANY, St. Paul, MN (US)

(72) Inventors: Mario A. Perez, Wellington, FL (US); Binhong Lin, Woodbury, MN (US); Tianyu Wu, St. Paul, MN (US); Claire Hartmann-Thompson, Lake Elmo, MN (US); Erik M. Townsend, South St. Paul, MN (US)

(21) Appl. No.: 19/101,696

(22) PCT Filed: Sep. 6, 2023
(86) PCT No.: PCT/IB2023/058817

§ 371 Date: Feb. 6, 2025

Related U.S. Application Data
(60) Provisional application No. 63/414,032, filed on Oct. 7, 2022.

(51) Int. Cl. C09J 7/30

(52) U.S. Cl. CPC C09J 7/30; C09J 2301/414; C09J 2301/416

(57) ABSTRACT

Articles, such as adhesive-articles, electronic articles, and abrasive articles, are described comprising a composition disposed on a substrate. The composition comprises i) cyclic olefin(s); ii) a ring opening metathesis polymerization catalyst; iii) a second polymerizable material; and iv) 10 an initiator for the second polymerizable material. The second polymerizable material is selected from the group consisting of a) epoxide-containing component(s); and b) (meth)acrylate monomer(s). The (meth)acrylate monomer(s) comprise a cycloaliphatic or heterocycloaliphatic group. The composition comprises greater than 25 wt. % of i) and greater than 25 wt. % of at least one of a) or b) based on the total of i) and iii). The cyclic olefins and/or second polymerizable 15 material are at least partially cured. Also described are compositions and methods.

### SUMMARY

In one embodiment, an article is described comprising a composition disposed on a substrate. The composition comprises i) cyclic olefin(s); ii) a ring opening metathesis polymerization catalyst; iii) a second polymerizable material; and iv) an initiator for the second polymerizable material. The second polymerizable material is selected from the group consisting of a) epoxide-containing component(s); and b) (meth)acrylate monomer(s). The (meth)acrylate monomer(s) comprise a cycloaliphatic or heterocycloaliphatic group. The composition comprises greater than 25 wt. % of i) and greater than 25 wt. % of at least one of a) or b) based on the total of i) and iii). In some embodiments, the composition comprises greater than 25 wt. % of cyclic olefin(s) and greater than 25 wt. % of epoxide-containing component. In other embodiments, the composition comprises greater than 25 wt. % of cyclic olefin(s) and greater than 25 wt. % of (meth)acrylate monomer(s) comprising a cycloaliphatic or heterocycloaliphatic group. The initiator is selected such that the second polymerizable material cures at different curing conditions than the cyclic olefins. In some embodiments, the concentration of cyclic olefin(s) and second polymerizable material is sufficient such that an interpenetrating polymer network is formed. The cyclic olefin(s) and/or second polymerizable material are at least partially cured. In the case of (e.g. transfer) film/tape articles, the cyclic olefin(s) and/or second polymerizable material are typically partially cured. In the case of other articles, such as abrasive and electronic articles, the cyclic olefin(s) and/or second polymerizable material are typically fully cured in the final article.

In another embodiment, a method of making an electronic article is described comprising A) applying a composition, as described herein, to a substrate. The method further comprises B) polymerizing the cyclic olefins, and C) curing the second polymerizable material. The method may comprise polymerizing the cyclic olefins prior to or after curing the second polymerizable material. Curing of the second polymerizable material may be achieved by exposing the composition to actinic (e.g ultraviolet) radiation. In some embodiments, the method further comprises contacting the composition with a second substrate prior to curing.

Also described are polymerizable compositions that comprise greater than 25 wt. % of i) and greater than 25 wt. % of at least one of a) or b) based on the total of i) and iii). In some embodiments, the sum of i) and iii) is at least 60 wt. % of the total composition. In other embodiments, the second polymerizable material is an epoxide-containing component or a (meth)acrylate monomer comprising a heterocycloaliphatic (e.g. isocyanurate) group.

### DETAILED DESCRIPTION

### Cyclic Olefins

The compositions (e.g. of the articles and methods) typically comprise one or more cyclic olefin(s). The cyclic olefins may be characterized be characterized as monomer. As used herein the term monomers refers to both monomers and oligomers that comprise cyclic olefins and typically have a molecular weight no greater than about 10,000 g/mole. When the cyclic olefin(s) are cured, a polymer is formed of polymerized cyclic olefins. The cyclic olefin monomers are generally mono-unsaturated (i.e. mono-olefin) or poly-unsaturated (i.e. comprising two or more carbon-carbon double bonds or in other words alkene groups). The double bond or in other words ethylenic unsaturation is not part of a (meth)acrylate or vinyl ether group. The cyclic olefin monomer may be mono- or poly-cyclic (i.e. comprising two or more cyclic groups). The cyclic olefin monomer may generally be a strained or unstrained cyclic olefin, provided the cyclic olefin is able to participate in a ROMP reaction either individually or as part of a ROMP cyclic olefin composition. Polymerized cyclic olefins are polymers made via ROMP of cyclic olefin monomers. Polymerized cyclic olefins may or may not contain unreacted cyclic olefin moieties, as at least one cyclic olefin moiety of each cyclic olefin monomer is converted into a non-cyclic olefin during ROMP.

The compositions may comprise cyclic diene monomers, including for example 1,3-cyclopentadiene, 1,3-cyclohexadiene, 1,4-cyclohexadiene, 5-ethyl-1,3-cyclohexadiene, 1,3-cycloheptadiene, cyclohexadiene, 1,5-cyclooctadiene, 1,3-cyclooctadiene, norbornadiene, cyclohexenylnorbornene, including oligomers thereof such as dimers, trimers, tetramers, pentamers, etc. The polyolefin cyclic materials are amenable to thermosetting.

In some embodiments, the composition comprises dicyclopentadiene (DCPD), depicted as follows:

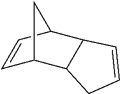

Various DCPD suppliers and purities may be used such as Lyondell 108 (94.6% purity), Veliscol UHP (99+% purity), Cymetech Ultrene (97% and 99% purities), and Hitachi (99+% purity).

In some embodiments, the composition comprises cyclopentadiene oligomers including trimers, tetramers, pentamers, and the like; depicted as follows:

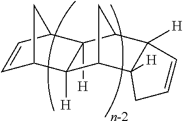

Cyclopentadiene oligomers, n is typically 3, 4 or 5

In some embodiments, the composition comprises cyclic diene monomer in the absence of mono-olefins.

In other embodiments, the composition further comprises a cyclic mono-olefin. Examples include cyclopentene, cyclohexene, cycloheptene, cyclooctene, cyclononene, cyclodecene, cycloundecene, cyclododecene, tricyclodecene, tetracyclodecene, octacyclodecene, and cycloeicosene, and substituted versions thereof such as 1-methylcyclopentene, 1-ethylcyclopentene, 1-isopropylcyclohexene, 1-chloropentene, 1-fluorocyclopentene, 4-methylcyclopentene, 4-methoxy-cyclopentene, 4-ethoxy-cyclopentene, cyclopent-3-ene-thiol, cyclopent-3-ene, 4-methylsulfanyl-cyclopentene, 3-methylcyclohexene, 1-methylcyclooctene, 1,5-dimethylcyclooctene, etc.

In some embodiments, the composition further comprises norbornene, depicted as follows:

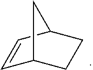

Suitable norbornene monomers include substituted norbornenes such as norbornene dicarboxylic anhydride (nadic anhydride); and as well as alkyl and cycloalkyl norbornenes including butyl norbornene, hexyl norbornene, octyl norbornene, decyl norbornene, and the like.

The cyclic olefin monomers and oligomers may optionally comprise substituents provided the monomer, oligomer, or mixture is suitable for metathesis reactions. The carbon atoms of the cyclic olefin moiety may optionally comprise substituents derived from radical fragments including halogens, pseudohalogens, alkyl, aryl, acyl, carboxyl, alkoxy, alkyl- and arylthiolate, amino, aminoalkyl, and the like, or in which one or more carbon atoms have been replaced by, for example, silicon, oxygen, sulfur, nitrogen, phosphorus, antimony, or boron. For example, the olefin may be substituted with one or more groups such as thiol, thioether, ketone, aldehyde, ester, ether, amine, amide, nitro, carboxylic acid, disulfide, carbonate, isocyanate, phosphate, phosphite, sulfate, sulfite, sulfonyl, carbodiimide, carboalkoxy, carbamate, halogen, or pseudohalogen. Similarly, the olefin may be substituted with one or more groups such as C1-C20 alkyl, aryl, acyl, C1-C20 alkoxide, aryloxide, C3-C20 alkyldiketonate, aryldiketonate, C1-C20 carboxylate, arylsulfonate, C1-C20 alkylsulfonate, C1-C20 alkylthio, arylthio, C1-C20 alkylsulfonyl, C1-C20 alkylsulfinyl, C-C20 alkylphosphate, and arylphosphate.

Preferred cyclic olefins can include dicyclopentadiene; tricyclopentadiene; dicyclohexadiene; norbornene; 5-methyl-2-norbornene; 5-ethyl-2-norbornene; 5-isobutyl-2-norbornene; 5,6-dimethyl-2-norbornene; 5-phenylnorbornene; 5-benzylnorbornene; 5-acetylnorbornene; 5-methoxycarbonylnorbornene; 5-ethoxycarbonyl-1-norbornene; 5-methyl-5-methoxy-carbonylnorbornene; 5-cyanonorbornene; 5,5,6-trimethyl-2-norbornene; cyclohexenylnorbornene; endo, exo-5,6-dimethoxynorbornene; endo, endo-5,6-dimethoxynorbornene; endo, exo-5-6-dimethoxycarbonylnorbornene; endo, endo-5,6-dimethoxycarbonylnorbornene; 2,3-dimethoxynorbornene; norbornadiene; tricycloundecene; tetracyclododecene; 8-methyltetracyclododecene; 8-ethyl-tetracyclododecene; 8-methoxycarbonyltetracyclododecene; 8-methyl-8-tetracyclo-dodecene; 8-cyanotetracyclododecene; pentacyclopentadecene; pentacyclohexadecene; higher order oligomers of cyclopentadiene such as cyclopentadiene tetramer, cyclopentadiene pentamer, and the like; and C2-C12 hydrocarbyl substituted norbornenes such as 5-butyl-2-norbornene; 5-hexyl-2-norbornene; 5-octyl-2-norbornene; 5-decyl-2-norbornene; 5-dodecyl-2-norbornene; 5-vinyl-2-norbornene; 5-ethylidene-2-norbornene; 5-isopropenyl-2-norbornene; 5-propenyl-2-norbornene; and 5-butenyl-2-norbornene, and the like. More preferred cyclic olefins include dicyclopentadiene, tricyclopentadiene, and higher order oligomers of cyclopentadiene, such as cyclopentadiene tetramer, cyclopentadiene pentamer, and the like, tetracyclododecene, norbornene, and C2-C12 hydrocarbyl substituted norbornenes, such as 5-butyl-2-norbornene, 5-hexyl-2-norbornene, 5-octyl-2-norbornene, 5-decyl-2-norbornene, 5-dodecyl-2-norbornene, 5-vinyl-2-norbornene, 5-ethylidene-2-norbornene, 5-isopropenyl-2-norbornene, 5-propenyl-2-norbornene, 5-butenyl-2-norbornene, and the like.

The cyclic olefins may be used alone or mixed with each other in various combinations to adjust the properties of the olefin monomer composition. For example, mixtures of cyclopentadiene dimer and trimers offer a reduced melting point and yield cured olefin copolymers with increased mechanical strength and stiffness relative to pure poly-DCPD. As another example, incorporation of norbornene, or alkyl norbornene comonomers tend to yield cured olefin copolymers that are relatively soft and rubbery.

In some embodiments, the cyclic olefin material comprises a mixture of DCPD monomer and cyclopentadiene oligomer. In some embodiments, the mixture comprises at least 25, 30, 35, 40 or 45 wt. % DCPD based on the total amount of cyclic olefin monomer(s) and oligomer(s). In some embodiments, the mixture comprises no greater than 75, 70, 65, 60, 55, or 50 wt. % DCPD based on the total amount a cyclic olefin monomer(s) and oligomer(s). In some embodiments, the mixture comprises at least 15, 20, 25, 30, or 35 wt. % of cyclic olefin oligomers, such as cyclopentadiene trimer and/or tetramer based on the total amount of cyclic olefin monomer(s) and oligomer(s). In some embodiments, the mixture comprises no greater than 60, 55, 50, 45, or 40 wt. % of cyclic olefin oligomers, such as cyclopentadiene trimer and/or tetramer based on the total amount of cyclic olefin monomer(s) and oligomer(s). In some embodiments, the mixture comprises at least 2, 3, 4, or 5 wt. % of cyclic olefin oligomers having greater than four cyclopentadiene repeat units, such as cyclopentadiene pentamer. In some embodiments, the mixture comprises no greater than 10, 9, 8, 7, 6, or 5 wt. % of cyclic olefin oligomers having greater than four cyclopentadiene repeat units, such as cyclopentadiene pentamer.

In some embodiments, the cyclic olefin material comprises a mixture of DCPD monomer and cyclopentadiene oligomer, in the absence of mono-olefins or in combination with a low concentration of mono-olefin. In this embodiment, the amount of mono-olefin is less than 25, 20, 15, 10, 9, 8, 7, 6, 5, 4, 3, 2, or 1 wt. % based on the total amount of cyclic olefin monomer(s) and oligomer(s).

In other embodiments, the mixture comprises at least 25, 30, 35, 40 or 45 wt. % of a mono-olefin such as a substituted norbornene, based on the total amount of cyclic olefin monomer(s) and oligomer(s). In some embodiments, the mixture comprises no greater than 75, 70, 65, 60, 55, or 50 wt. % mono-olefin (e.g. C4-C12 (e.g. C8) alkyl norbornene) based on the total amount a cyclic olefin monomer(s) and oligomer(s). In some embodiments, the mixture comprises at least 15, 20, 25, 30, or 35 wt. % of cyclic olefin oligomers, such as cyclopentadiene trimer and/or tetramer based on the total amount a cyclic olefin monomer(s) and oligomer(s). In some embodiments, the mixture comprises no greater than 60, 55, 50, 45, or 40 wt. % of cyclic olefin oligomers, such as cyclopentadiene trimer and/or tetramer based on the total amount of cyclic olefin monomer(s) and oligomer(s). In some embodiments, the mixture comprises at least 2, 3, 4, or 5 wt. % of cyclic olefin oligomers having greater than four cyclopentadiene repeat units, such as cyclopentadiene pentamer. In some embodiments, the mixture comprises no greater than 10, 9, 8, 7, 6, or 5 wt. % of cyclic olefin oligomers having greater than four cyclopentadiene repeat units, such as cyclopentadiene pentamer. In some embodiments, the mixture comprises no greater than 5, 4, 3, 2, or 1 wt. % of DCPD monomer. In other embodiments, the mixture comprises no greater than 25 or 20 wt. % of DCPD monomer.

The composition (e.g., of the articles) described herein comprise greater than 25 wt. % of cyclic olefin(s) based of the total amount of cyclic olefin(s) and second polymerizable material. When the composition comprises other polymerizable materials in addition to the cyclic olefin(s) and second polymerizable material described herein, the composition typically comprises greater than 25 wt. % of cyclic olefin(s) based of the total amount of polymerizable materials. In some embodiments, the composition comprise at least 30, 35, 40, 45, 50, 55, 60, 65, 70, 75, or 80 wt. % of cyclic olefin(s). In some embodiments, the composition comprises no greater than 80, 75, 70, 65, 60, 55, 50, 45, 40, 35, or 30 wt. % of cyclic olefin(s).

The cyclic olefins can provide physical properties such as low Dielectric Constant (Dk), low dielectric loss, and low Tan Delta properties that are amenable to electronic articles, especially when present at higher concentrations or in combination with inorganic fillers. The Dielectric Constant (Dk) @10 GHz of the cured film can be less than 2.7, 2.6, 2.5, 2.4, 2.3 or 2.2. The Tan Delta @10 GHz of the cured film can be less than 0.010, 0.0090, 0.0080, 0.0070, 0.0060, 0.0050, 0.0040, 0.0030, or 0.0020. Low tan delta values can be obtained by use of higher aliphatic content cyclic olefins. The cyclic olefins can also provide higher heat stability and moisture resistance, which is advantageous for both electronic and abrasive articles.

### ROMP Catalysts

The compositions (e.g., of the articles and methods) comprise a ring opening metathesis polymerization (ROMP) catalyst. Such organometallic catalysts are able to perform ROMP on cyclic olefin monomers to produce polymers therefrom. Group 8 transition metals, such as ruthenium and osmium, carbene compounds have been described as effective catalysts for ring opening metathesis polymerization (ROMP). See for example U.S. Pat. No. 10,239,965; incorporated herein by reference.

In typical embodiments, the catalyst is a metal carbene olefin metathesis catalyst. Such catalysts typically have the following structure:

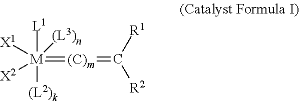

wherein
M is a Group 8 transition metal;
L¹, L², and L³ are independently neutral electron donor ligands; n is 0 or 1; m is 0, 1, or 2; k is 0 or 1;
X¹ and X² are independently anionic ligands; and
R¹ and R² are independently selected from hydrogen, hydrocarbyl, substituted hydrocarbyl, heteroatom-containing hydrocarbyl, substituted heteroatom-containing hydrocarbyl, and functional groups.

Typical metal carbene olefin metathesis catalysts contain Ru or Os as the Group 8 transition metal, with Ru being preferred.

A first group of metal carbene olefin metathesis catalysts are commonly referred to as First Generation Grubbs-type catalysts, and have the structure of Catalyst Formula (I). For the first group of metal carbene olefin metathesis catalysts, M is a Group 8 transition metal, m is 0, 1, or 2, and n, X₁, X², L¹, L², and L³ are described as follows.

For the first group of metal carbene olefin metathesis catalysts, n is 0, and L¹ and L² are independently selected from phosphine, sulfonated phosphine, phosphite, phosphinite, phosphonite, arsine, stibine, ether, (including cyclic ethers), amine, amide, imine, sulfoxide, carboxyl, nitrosyl, pyridine, substituted pyridine, imidazole, substituted imidazole, pyrazine, substituted pyrazine and thioether. Exemplary ligands are trisubstituted phosphines. Typical trisubstituted phosphines are of the formula PR^{H1}R^{H2}R^{H3}, where R^{H1}, R^{H2}, and R^{H3} are each independently substituted or unsubstituted aryl or C1-C10 alkyl, particularly primary alkyl, secondary alkyl, or cycloalkyl. In some embodiments, L¹ and L² are independently selected from the group consisting of trimethylphosphine (PMe₃), triethylphosphine (PEt₃), tri-n-butylphosphine (PBu₃), tri(ortho-tolyl)phosphine (P-o-tolyl₃), tri-tert-butylphosphine (P-tert-Bu₃), tricyclopentylphosphine (PCyclopentyl₃). tricyclohexylphosphine (PCy₃), triisopropylphosphine (P-i-Pr₃), trioctylphosphine (POct₃), triisobutylphosphine, (P-i-Bu₃), triphenylphosphine (PPh₃), tri(pentafluorophenyl)phosphine (P(C₆F₅)₃), methyldiphenylphosphine (PMcPlu). dimethylphenylphosphine (PMePh₂). and diethylphenylphosphine (PEt₂Ph). Alternatively, L¹ and L² may be independently selected from phosphabicycloalkane (e.g., monosubstituted 9-phosphabicyclo-[3.3.1]nonane, or monosubstituted 9-phosphabicyclo[4.2.1]nonane] such as cyclohexylphoban, isopropylphoban, ethylphoban, methylphoban, butylphoban, pentylphoban and the like.

X¹ and X² are anionic ligands, and may be the same or different, or are linked together to form a cyclic group, typically although not necessarily a five- to eight-membered ring. In some embodiments, X¹ and X² are each independently hydrogen, halide, or one of the following groups: C1-C20 alkyl, C5-C24 aryl, C1-C20 alkoxy, C5-C24 aryloxy, C2-C20 alkoxycarbonyl, C6-C24 aryloxycarbonyl, C2-C24 acyl, C2-C24 acyloxy, C1-C20 alkylsulfonato, C5-C24 arylsulfonato, C1-C20 alkylsulfanyl, C5-C24 arylsulfanyl, C1-C20 alkylsulfinyl, NO3, —N═C=0, —N═C═S, or C5-C24 arylsulfinyl. Optionally, X1 and X2 may be substituted with one or more moieties selected from C1-C12 alkyl, C1-C12 alkoxy, C5-C24 aryl, and halide, which may, in turn, with the exception of halide, be further substituted with one or more groups selected from halide, C1-C6 alkyl, C1-C6 alkoxy, and phenyl. In some embodiments, X1 and X2 are halide, benzoate, C2-C6 acyl, C2-C6 alkoxycarbonyl, C1-C6 alkyl, phenoxy, C1-C6 alkoxy, C1-C6 alkylsulfanyl, aryl, or C1-C6 alkylsulfonyl. In some preferred embodiments, X¹ and X² are each halide, CF₃CO₂, CH₃CO₂, CFH₂CO₂, (CH₃)₃CO, (CF₃)₂(CH₃)CO, (CF₃)(CH₃)₂CO, PhO, MeO, EtO, tosylate, mesylate, or trifluoromethane-sulfonate. In some preferred embodiments, X¹ and X² are each chloride.

R¹ and R² are independently selected from hydrogen, hydrocarbyl (e.g., C1-C20 alkyl, C2-C20 alkenyl, C2-C20 alkynyl, C5-C24 aryl, C6-C24 alkaryl, C6-C24 aralkyl, etc.), substituted hydrocarbyl (e.g., substituted C1-C20 alkyl, C2-C20 alkenyl, C2-C20 alkynyl, C5-C24 aryl, C6-C24 alkaryl, C6-C24 aralkyl, etc.), heteroatom-containing hydrocarbyl (e.g., heteroatom-containing C1-C20 alkyl, C2-C20 alkenyl, C2-C20 alkynyl, C5-C24 aryl, C6-C24 alkaryl, C6-C24 aralkyl, etc.), and substituted heteroatom-containing hydrocarbyl (e.g., substituted heteroatom-containing C1-C20 alkyl, C2-C20 alkenyl, C2-C20 alkynyl, C5-C24 aryl, C6-C24 alkaryl, C6-C24 aralkyl, etc.), and functional groups. R¹ and R² may also be linked to form a cyclic group, which may be aliphatic or aromatic, and may contain substituents and/or heteroatoms. Generally, such a cyclic group will contain 4 to 12, preferably 5, 6, 7, or 8 ring atoms.

In some embodiments, R¹ is C1-C6 alkyl, C2-C6 alkenyl, and C5-C14 aryl.

In some embodiments, R² is phenyl, vinyl, methyl, isopropyl, or t-butyl, optionally substituted with one or more moieties selected from C1-C6 alkyl, C1-C6 alkoxy, phenyl, and a functional group Fn. Suitable functional groups (“Fn”) include phosphonato, phosphoryl, phosphanyl, phosphino, sulfonato, C1-C20 alkylsulfanyl, C5-C20 arylsulfanyl, C1-C20 alkylsulfonyl, C5-C20 arylsulfonyl, C1-C20 alkylsulfinyl, C5-C20 arylsulfinyl, sulfonamido, amino, amido, imino, nitro, nitroso, hydroxyl, C1-C20 alkoxy, C5-C20 aryloxy, C2-C20 alkoxy carbonyl, C5-C20 aryloxy carbonyl, carboxyl, carboxylato, mercapto, formyl, C1-C20 thioester, cyano, cyanato, thiocyanato, isocyanate, thioisocyanate, carbamoyl, epoxy, styrenyl, silyl, silyloxy, silanyl, siloxazanyl, boronato, boryl, or halogen, or a metal-containing or metalloid-containing group (wherein the metal may be, for example, Sn or Ge).

In some embodiments, R² is phenyl or vinyl substituted with one or more moieties selected from methyl, ethyl, chloro, bromo, iodo, fluoro, nitro, dimethylamino, methyl, methoxy, and phenyl. In some favored embodiments, R² is phenyl or —CH═C(CH₃)₂.

In some embodiments, one or both of R¹ and R² may have the structure —(W)ₙ—U⁺V⁻, wherein W is selected from hydrocarbylene, substituted hydrocarbylene, heteroatom-containing hydrocarbylene, or substituted heteroatom-containing hydrocarbylene; U is a positively charged Group 15 or Group 16 element substituted with hydrogen, hydrocarbyl, substituted hydrocarbyl, heteroatom-containing hydrocarbyl, or substituted heteroatom-containing hydrocarbyl; V is a negatively charged counterion; and n is zero or 1. Furthermore, R¹ and R² may be taken together to form an indenylidene moiety, such as phenylindenylidene.

In some embodiments, any one or more of X¹, X², L¹, L², L³, R¹ and R² may be attached to a support or two or more (e.g. three or four) of said groups can be bonded to one another to form one or more cyclic groups, including bidentate or multidentate ligands, as disclosed, for example, in U.S. Pat. No. 5,312,940, incorporated herein by reference. When two or more of X¹, X², L¹, L², L³, R¹ and R² are linked to form cyclic groups, those cyclic groups may contain 4 to 12, preferably 4,

5, 6, 7 or 8 atoms, or may comprise two or three of such rings, which may be either fused or linked. The cyclic groups may be aliphatic or aromatic, and may be heteroatom-containing and/or substituted. The cyclic group may, in some cases, form a bidentate ligand or a tridentate ligand. Examples of bidentate ligands include, but are not limited to, bisphosphines, dialkoxides, alkyldiketonates, and aryldiketonates.

Other metal carbene olefin metathesis catalysts, commonly referred to as Second or Third Generation Grubbs-type catalysts, have the structure of Catalyst Formula (I), wherein L¹ is a carbene ligand having the structure of formula (II)

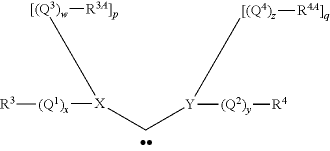

wherein M, m, n, X¹, X², L², L³, R¹ and R² are as previously defined Formula I;
X and Y are heteroatoms typically selected from N, O, S, and P. Since O and S are divalent, p is necessarily zero when X is O or S, q is necessarily zero when Y is O or S, and k is zero or 1. However, when X is N or P, then p is 1, and when Y is N or P, then q is 1. In a preferred embodiment, both X and Y are N;
Q¹, Q², Q³, and Q⁴ are linkers, e.g., hydrocarbylene (including substituted hydrocarbylene, heteroatom-containing hydrocarbylene, and substituted heteroatom-containing hydrocarbylene, such as substituted and/or heteroatom-containing alkylene) or —(CO)—, and w, x, y, and z are independently zero or 1, meaning that each linker is optional. Preferably, w, x, y, and z are all zero. Further, two or more substituents of adjacent atoms within Q¹, Q², Q³, and Q⁴ may be linked to form an additional cyclic group;
R³, R^{3A}, R⁴, and R^{4A} are independently selected from hydrogen, hydrocarbyl, substituted hydrocarbyl, heteroatom-containing hydrocarbyl, and substituted heteroatom-containing hydrocarbyl. In addition, X and Y may be independently selected from carbon and one of the heteroatoms mentioned above, preferably no more than one of X or Y is carbon. Also, L² and L³ may be taken together to form a single bidentate electron-donating heterocyclic ligand. Furthermore, R¹ and R² may be taken together to form an indenylidene moiety, preferably phenylindenylidene. Moreover, X¹, X², L², L³, X and Y may be further coordinated to boron or to a carboxylate;
Any two or more of X¹, X², L¹, L², L³, R¹, R² R³, R^{3A}, R⁴, R^{4A}, Q¹, Q², Q³, and Q⁴ can be bonded to one another to form one or more cyclic groups or can also be taken to be -A-Fn, wherein “A” is a divalent hydrocarbon moiety and Fn is a functional group as previously described.

Further, with the exception of L¹ such groups may be bonded to a support.

A particular class of such carbene are commonly referred to as N-heterocyclic carbene (NHC) ligands.

Examples of N-heterocyclic carbene (NHC) ligands and acyclic diaminocarbene ligands suitable as L¹ thus include, but are not limited to, the following where DIPP or DiPP is diisopropylphenyl and Mes is 2,4,6-trimethylphenyl:

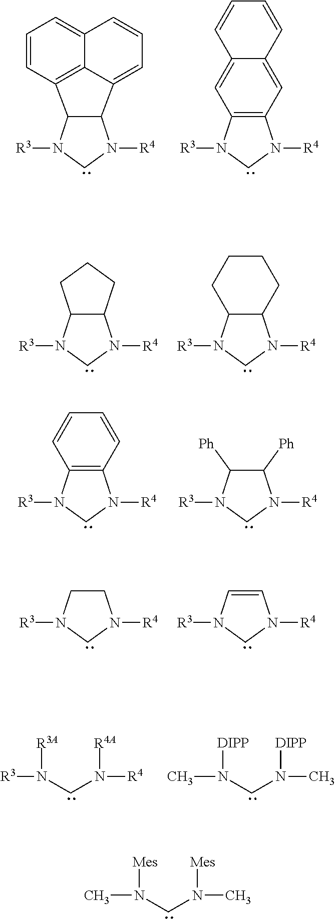

Representative metal carbene olefin metathesis catalysts include for example bis(tricyclohexylphosphine) benzylidene ruthenium dichloride, bis(tricyclohexylphosphine) dimethylvinylmethylidene ruthenium dichloride, bis(tricyclopentylphosphine) dimethylvinylmethylidene ruthenium dichloride, (tricyclohexylphosphine)(1,3-dimesityl-4,5-dihydroimidazol-2-ylidene) benzylidene ruthenium dichloride, (tricyclopentylphosphine)(1,3-dimesityl-4,5-dihydroimidazol-2-ylidene) dimethylvinylmethylidene ruthenium dichloride, (tricyclohexylphosphine)(1,3-dimesityl-4,5-dihydroimidazol-2-ylidene) dimethylvinylmethylidene ruthenium dichloride, (tricyclohexylphosphine)(1,3-dimesitylimidazol-2-ylidene) benzylidene ruthenium dichloride, (tricyclopentylphosphine)(1,3-dimesitylimidazol-2-ylidene) dimethylvinylmethylidene ruthenium dichloride, and (tricyclohexylphosphine)(1,3-dimesitylimidazol-2-ylidene) dimethylvinylmethylidene ruthenium dichloride.

Numerous metal carbene olefin metathesis catalysts are known, such as described in previously cited U.S. Pat. No. 10,239,965.

In some embodiments, the composition (e.g. of the article) comprises a latent ring opening metathesis polymerization catalyst. Latent ring opening metathesis polymerization catalysts exhibit little or no catalytic activity (e.g. polymerization of the cyclic olefin) for at least 24 hours room temperature. The composition or article can be stored at cold temperatures to prevent premature activation of thermally activated catalysts. Likewise, the composition or coated (e.g. adhesive tape) article can be stored in a dark box or dark packaging materials to prevent premature activation of light activated catalysts. Latent ring opening metathesis polymerization catalysts can be triggered or in other words activated with heat (i.e. thermal activation), actinic (e.g. ultraviolet) radiation, a chemical compound, or a combination thereof. Actinic-radiation-activated catalysts can be preferred for bonding heat sensitive substrates comprised of organic polymeric materials.

However, for bonding other substrates, the (e.g. latent) catalysts may be heat activated. In typical embodiments, the heat activation temperature is well above room temperature. For example, the heat activation temperature is at least 50, 60, 70, 80, 90 or 100° C. The heat activation temperature may range up to 130, 140, or 150° C. In one embodiment, thermally latent catalysts includes isomers that are inactive at room temperature yet active at temperatures ranging from 50° C. to 90° C. Several heat-activatable ROMP catalysts are available from Materia, Inc (Pasadena, CA, USA) including those available as trade designations “Proxima CT-762” and “Proxima CT-714.

The composition typically comprises the ROMP catalyst in an amount ranging from about 0.0001 wt. % to 2 wt. % catalyst based on the total weight of the composition. In some embodiments, the composition typically comprises at least 0.0005, 0.001, 0.005, 0.01, 0.05, 0.10, 0.15 or 0.20 wt. % catalyst. In some embodiments, the composition typically comprises no greater than 1.5, 1, or 0.5 wt. % catalyst.

### Second Polymerizable Material

The composition (e.g., of the articles and methods) comprises a second polymerizable material. The second polymerizable material may be characterized as a monomer. As used herein the term monomers refers to both monomers and oligomers that comprise polymerizable (e.g. epoxy or (meth)acrylate groups) typically having a molecular weight no greater than about 10,000 g/mole. The second polymerizable material polymerizes or in other words cure at different curing conditions than the cyclic olefins. In typical embodiments, the second polymerizable material cures via a different mechanism other than ROMP. When the second polymerizable material cures, a polymer is formed of polymerized second material.

In some embodiments, the second polymerizable material is an epoxide-containing component, i.e. an organic compound having one or more oxirane ring polymerizable by a ring opening mechanism. The epoxide functional group can be cationically polymerized or in other words cured.

The epoxide-containing component may be aliphatic, cycloaliphatic, heterocyclic, aromatic, hydrogenated, or mixtures thereof. Preferred epoxides contain more than 1.5 or 2 epoxide groups per molecule.

The epoxide-containing component include compounds having the general formula:

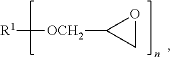

where R¹ is an alkyl, alkyl ether, or aryl group and n ranges from 1 to 6.

Epoxide-containing components include aromatic glycidyl ethers, e.g., such as those prepared by reacting a polyhydric phenol with an excess of epichlorohydrin, cycloaliphatic glycidyl ethers, hydrogenated glycidyl ethers, and mixtures thereof. Such polyhydric phenols may include resorcinol, catechol, hydroquinone, and the polynuclear phenols such as p,p′-dihydroxydibenzyl, p,p′-dihydroxydiphenyl, p,p′-dihydroxyphenyl sulfone, p,p′-dihydroxybenzophenone, 2,2′-dihydroxy-1,1-dinaphthylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

The epoxide-containing component can include linear polymeric epoxides having terminal epoxy groups (e.g., a diglycidyl ether of a polyoxyalkylene glycol), polymeric epoxides having skeletal epoxy groups (e.g., polybutadiene poly epoxy), polymeric epoxides having pendant epoxy groups (e.g., a glycidyl methacrylate polymer or copolymer), or a mixture thereof.

Other useful epoxide-containing component are polyhydric phenolic formaldehyde condensation products as well as polyglycidyl ethers that contain as reactive groups only epoxy groups or in combination with hydroxy groups. Useful curable epoxy resins are also described in various publications including, for example, “Handbook of Epoxy Resins” by Lee and Nevill, McGraw-Hill Book Co., New York (1967), and Encyclopedia of Polymer Science and Technology, 6, p. 322 (1986).

Examples of commercially available epoxide-containing components include diglycidyl ethers of bisphenol A (e.g., those available under the trade names EPON 828, EPON 1001, EPON 1004, EPON 2004, EPON 1510, and EPON 1310 from Momentive Specialty Chemicals, Inc., (Waterford, NY, USA) and those under the trade designations D.E.R. 331, D.E.R. 332, D.E.R. 334, and D.E.N. 439 available from Dow Chemical Co., Midland, MI, USA.); diglycidyl ethers of bisphenol F (that are available, e.g., under the trade designation ARALDITE GY 281 available from Huntsman Corporation, The Woodlands, TX, USA); silicone resins containing diglycidyl epoxy functionality; flame retardant epoxy resins (e.g., that are available under the trade designation D.E.R. 560, a brominated bisphenol type epoxy resin available from Dow Chemical Co.); and 1,4-butanediol diglycidyl ethers.

In some embodiments, the composition further comprises a hydroxyl-containing component. The hydroxyl-containing component can act as a chain transfer agent for the epoxide-containing component when the epoxy groups react via a cationic mechanism.

Suitable hydroxyl-containing components include liquid polyols as well as polymeric hydroxyl-containing (e.g. terminated) components including polyester polyols, as known in the art. In typical embodiments, the hydroxyl containing components may average a least 1.5, 2, 2.5, and is typically no greater than 3, 2.5, or 2 hydroxyl groups per molecule (chain). The hydroxyl containing components may have a molecular weight (Mn) of at least 500, 750, or 1,000 g/mol. In some embodiments, the hydroxyl-containing components have a molecular weight (Mn) no greater than 5,000; 4,000; 3,000; 2,500; 2,000; or 1,500 g/mol.

In one embodiment, the hydroxyl-containing component is a hydroxyl-terminated polyolefin (e.g. butadiene). In some embodiments, the polyolefin comprises ethylenically unsaturated groups (e.g. 1,2 vinyl) such as in the case of polybutadiene. The 1,2 vinyl content is typically 60-70 wt. % of the hydroxyl-containing polyolefin (e.g. butadiene). In other embodiments, the polyolefin (e.g. butadiene) may be partially or fully hydrogenated. When partially hydrogenated, the 1,2 vinyl content may be less than 60, 50, 40, 30, 20, or 10 wt. % of the hydroxyl-containing polyolefin (e.g. butadiene). It is surmised that the vinyl groups may copolymerize with the cyclic olefins. Hydroxyl-containing (e.g. terminated) polyolefin (e.g. butadiene) materials are available from Cray Valley (Exton, PA, USA) as the trade designations “Krasol LBH 2000”, “Krasol LBH-P 2000”, “Krasol LBH 3000”, “Krasol LBH-P 3000”, “Krasol HLBH-P 2000”, and “Krasol HLBH-P 3000”.

As illustrated by Example 11, in the absence of a hydroxyl containing component, the curing of the epoxy resin may be incomplete, as evidenced by the presence of liquid after thermal curing. It is surmised that by inclusion of a hydroxy-containing component, such as a hydroxy-terminated polybutadiene, the curing efficiency of the epoxy resin can be improved. The curing of the epoxy resin can also be improved by adjusting the curing conditions such as increasing the time and/or increasing the temperature.

In some embodiments the second polymerizable material is an epoxidized polyolefin, such as epoxidized polybutadiene, wherein one or more of the carbon-carbon double bonds in the oligomer or polymer has been epoxidized (i.e. converted into an oxirane ring). In some embodiments, the epoxidized polyolefin (e.g. butadiene) has an epoxy equivalent weight (as determined by ATO-822) of at least 100, 150, 200, 250, or 300 g/equivalent. In some embodiments, the epoxy equivalent weight is no greater than 1000, 900, 700, 600, 500, 400, or 300 g/equivalent.

In some embodiments, the epoxidized polyolefin (e.g. butadiene) further comprises hydroxyl groups. The epoxidized polyolefin (e.g. butadiene) may have the same average hydroxyl groups per molecule (chain) and molecular weight, as just described for the hydroxyl-containing components.

In some embodiments, the epoxidized polyolefin (e.g. butadiene) may further comprise ethylenically unsaturated moieties, such as 1,2 vinyl groups. The wt. % of vinyl groups can be at least 5, 10, 15 or 20 wt. % (as determined by proton NMR/IR), based on the total wight of the epoxidized polyolefin (e.g. butadiene). In some embodiments, the wt. % of vinyl is no greater than 25 wt. %. It is surmised that the vinyl groups may copolymerize with the cyclic olefins. The epoxidized polyolefin (e.g. butadiene) may have the following formula:

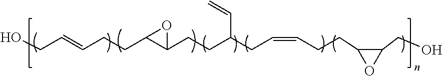

Examples of an epoxidized polyolefin (e.g. butadiene) further comprising hydroxyl groups and ethylenically unsaturated moieties can be obtained as “Poly bd 605E” and “Poly bd 700S” available from Cray Valley (Exton, PA, USA).

Functionalized polyolefins, comprising polymerized hydrocarbons having 4 or more carbon atoms, such as butadiene, typically have a Tg less than 25, 0, −25, or −50° C. In some embodiments, the functionalized polybutadiene has a Tg of at least −80, −75, −70, −65, −60, −55, −50, −45, −40, or −35° C. The addition of low Tg second polymerizable material can improve the flexibility of the polymerized cyclic olefin(s).

The composition may have combinations of different epoxide-containing components. For example, the composition may have a first epoxy resin, lacking a polybutadiene moiety, in combination with an epoxidized polybutadiene.

In other embodiments, the second polymerizable material is a (meth)acrylate monomer comprising a cycloaliphatic or heterocycloaliphatic group. Such monomers are free-radically polymerizable and can undergo addition polymerization. Such monomers comprise at least one, and typically two or more (meth)acrylate groups. The number of (meth)acrylate groups is typically no greater than 3, 4, 5, or 6.

Monomers with a cycloaliphatic or heterocycloaliphatic are typically high glass transition temperature (Tg) monomers. In some embodiments, a homopolymer of the (meth)acrylate monomer(s) has a Tg of at least 50, 75, 100, 125, 150 or 175° C. In some embodiments, the Tg of the other ethylenically unsaturated monomer(s) is no greater than about 200° C. When the composition comprises a sufficient amount of high Tg second polymerizable material, the composition can be more dimensionally stable at elevated temperatures.

Illustrative mono (meth)acrylates that comprises a cycloaliphatic group include for example isobornyl acrylate (Tg=94° C.), isobornyl methacrylate (Tg=110° C.), cyclohexyl methacrylate

(Tg=116° C.), t-butyl cyclohexyl acrylate (Tg=65° C.), and t-butyl cyclohexyl methacrylate (Tg=117° C.).

One representative di(meth)acrylate monomer that comprises a cycloaliphatic group is tricyclodecanedimethanol diacrylate (depicted as follows), reported to have a Tg of 186° C., as measured according to Dynamic Mechanical Analysis.

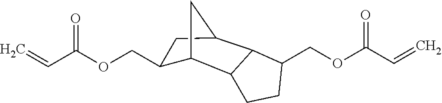 [SMILES: C=CC(=O)OCC1CC2CC1C1CCC(COC(=O)C=C)C21]

Other di(meth)acrylate monomers that comprise a cycloaliphatic group include cyclohexyl acrylate (Tg=19° C.), cyclohexyl methacrylate (Tg=92° C.), isobornyl acrylate (Tg=94° C.), isobornyl methacrylate (Tg=110° C.), tetrahydrofuran acrylate, and (meth)acrylate monomer comprising norbene moieties.

Another representative (meth)acrylate monomer comprising an heterocyclic (e.g. isocyanurate) group is tris[(2-acryloyloxy)ethyl]isocyanurate (depicted as follows)

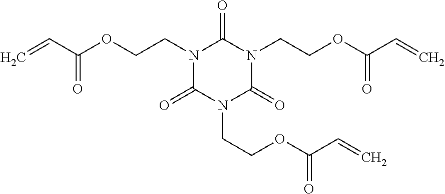 [SMILES: C=CC(=O)OCCn1c(=O)n(CCOC(=O)C=C)c(=O)n(CCOC(=O)C=C)c1=O]

In some embodiments, particularly in combination with the cyclo(hetero)aliphatic (meth)acrylate monomers, the composition can optionally comprise other ethylenically unsaturated free-radically polymerizable monomers comprising (meth)acrylate groups. For example, the composition may comprise a total of 40 wt. % of (meth) acrylate monomer wherein 30 wt. % is a (hetero)-cycloaliphatic (meth)acrylate monomer and 10 wt. % is a different (meth)acrylate monomer, lacking a (hetero)cycloaliphatic moiety.

The (hetero)cyclic (meth)acrylate monomers typically lack (e.g. carboxylic) acidic groups. In some embodiments, the compositions lack components (e.g. monomers) with acidic groups, such as acrylate acid, since acidic group can be corrosive, particularly when applied to metallic substrates.

Useful (meth)acrylates, for example, include mono-, di- or poly-acrylates and methacrylates such as methyl acrylate, methyl methacrylate, ethyl acrylate, isopropyl methacrylate, n-hexyl acrylate, stearyl acrylate, allyl acrylate, glycerol diacrylate, glycerol triacrylate, hexanediol diacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, urethane acrylates, and (meth)acrylates of polyethylene glycols of molecular weights ranging from 200-500 g/mole.

The composition (e.g. of the articles and method) comprises greater than 25 wt. % of at least one second polymerizable material in an amount greater than 25 wt. % based on the total amount of cyclic olefin(s) and second polymerizable material. Thus, the composition may comprise greater than 25 wt. % epoxide-containing component(s) monomer or greater than 25 wt. % of (hetero)cycloaliphatic (meth)acrylate monomer(s). In another embodiment, the composition may comprise greater than 25 wt. % of epoxide-containing component(s) and greater than 25 wt. % of (hetero)cycloaliphatic (meth)acrylate monomer(s). In some embodiments, the composition comprises at least 30, 35, 40, 45, 50, 55, 60, 65, 70, 75, or 80 wt. % of epoxide-containing component(s) and/or (hetero)cycloaliphatic (meth)acrylate monomer(s). In some embodiments, the composition comprises no greater than 80, 75, 70, 65, 60, 55, 50, 45, 40, 35, or 30 wt. % epoxide-containing component(s) and/or (hetero)cycloaliphatic (meth)acrylate monomer(s). When the composition comprises other polymerizable materials in addition to the cyclic olefin(s) and second polymerizable material described herein, the composition typically comprises greater than 25 wt. % of a second polymerizable material based of the total amount of polymerizable materials.

When epoxide-containing component(s) and/or (hetero)cycloaliphatic (meth)acrylate monomer(s) are present in a sufficient amount such second polymerizable material can independently form a polymer that is different that the polymer of the polymerized cyclic olefin(s). In typical embodiments, an interpenetrating network (IPN) is formed. An interpenetrating polymer network is a polymer comprising two or more networks which are at least partially interlaced on a polymer scale but not covalently bonded to each other. The entanglement of the polymer network can affect the physical properties. In some embodiments, the polymer networks may also be crosslinked. For example, the vinyl groups of the epoxidized butadiene described above may copolymerize during the polymerizable of the cyclic olefins. In this embodiment, the network cannot be separated unless chemical bonds are broken.

In some embodiments, each polymer network may have a different Tg. Thus, the composition may have a first Tg of the polymerized cyclic olefin(s) and a second Tg of the cured second polymerizable material. It is also surmised that the composition may have at least three polymer networks, a polymerized cyclic olefin polymer network, a polymerized epoxy component network, and a polymerized (hetero)cycloaliphatic monomer network. This can occur for example, when the composition comprises at least 30 wt. % cyclic olefin(s), at least 30 wt. % epoxide-containing components, and at least 30 wt. % of hetero(cyclic)aliphatic monomer(s).

### Initiators for Second Polymerizable Material

The compositions (e.g. of the articles) typically comprise an initiator for the second polymerizable material. The composition is typically provided for use in making the articles comprising the initiator pre-mixed with the other components. The initiator may be added immediately prior to use. The initiator is typically selected such that the second polymerizable material cures at different curing conditions than the cyclic olefins. In some embodiments, the initiator is a cationic initiator, such as a thermal acid generator or photoacid generator for curing the epoxide groups or a free-radical initiator for curing the (meth)acrylate groups. The ROMP catalyst is typically thermally activated.

The free-radical initiator may be a thermal initiator or a photoinitiator of a type and amount effective to polymerize the (meth)acrylic portion of the second polymerizable material. The initiators are typically employed at concentrations ranging from about 0.0001 to about 3.0 parts by weight, preferably from about 0.001 to about 1.0 parts by weight, and more preferably from about 0.005 to about 0.5 parts by weight of the composition.

Suitable thermal initiators include but are not limited to those selected from the group consisting of azo compounds such as VAZO 64 (2,2′-azobis(isobutyronitrile)), VAZO 52 (2,2′-azobis(2,4-dimethylpentanenitrile)), and VAZO 67 (2,2′-azobis-(2-methylbutyronitrile)) available from Chemours (Wilmington, DE, USA), peroxides such as benzoyl peroxide and lauroyl peroxide, and mixtures thereof. A preferred oil-soluble thermal initiator is (2,2′-azobis-(2-methylbutyronitrile)).

Examples of useful photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); 1-hydroxy cyclohexyl phenyl ketone; and acylphosphine oxide derivatives and acylphosphonate derivatives (e.g., bis(2,4,6-trimethylbenzoyl)phenylphosphine oxide, diphenyl-2, 4,6-trimethylbenzoylphosphine oxide, isopropoxyphenyl-2,4,6-trimethylbenzoylphosphine oxide, or dimethyl pivaloylphosphonate). Many photoinitiators are available, for example, from IGM Resins (Charlotte, NC, USA) under the trade designation “OMNIRAD”. The photoinitiator may be selected, for example, based on the desired wavelength for curing and compatibility with the monomers.

### Description of Photoacid Generators

Some articles and compositions described herein comprise a photoacid generator, as an initiator for the second polymerizable material. The photoacid generator is of a type and amount effective for cationic polymerization on the epoxide groups of the second polymerizable material. Preferred photoacid generators are typically ionic photoacid generators or triazine compounds.

Upon irradiation with light energy, photoacid generators undergo a fragmentation reaction and release one or more molecules of Lewis or Bronsted acid that induce polymerization of the epoxy portion of the second polymerizable material. Useful photoacid generators are thermally stable, do not undergo thermally induced reactions with the composition, and are readily dissolved or dispersed in the composition. Typical photoacid generators are those in which the incipient acid has a pKa value of <0. Photoacid generators are known and reference may be made to K. Dietliker, Chemistry and Technology of UV and EB Formulation for Coatings, Inks and Paints, vol. Ill, SITA Technology Ltd., London, 1991. Further reference may be made to Kirk-Othmer Encyclopedia of Chemical Technology, 4th Edition, Supplement Volume, John Wiley and Sons, New York, 1992, pp 253-255.

Cations useful as the cationic portion of ionic photoinitiators include organic onium cations, for example those described in U.S. Pat. Nos. 4,250,311, 3,708,296, 4,069,055, 4,216,288, 5,084,586, 5,124,417, 5,554,664 and such descriptions incorporated herein by reference, including aliphatic or aromatic Group IVA VIIA (CAS version) centered onium salts, preferably I-, S-, P-, Se- N- and C-centered onium salts, such as those selected from, sulfoxonium, iodonium, sulfonium, selenonium, pyridinium, carbonium and phosphonium, and most preferably I-, and S-centered onium salts, such as those selected from sulfoxonium, diaryliodonium, triarylsulfonium, diarylalkylsulfonium, dialkylarylsulfonium, and trialkylsulfonium wherein “aryl” and “alkyl” are as defined and having up to four independently selected substituents. The substituents on the aryl or alkyl moieties will preferably have less than 30 carbon atoms and up to 10 heteroatoms selected from N, S, non-peroxidic O, P, As, Si, Sn, B, Ge, Te, Se. Examples include hydrocarbyl groups such as methyl, ethyl, butyl, dodecyl, tetracosanyl, benzyl, allyl, benzylidene, ethenyl and ethynyl; hydrocarbyloxy groups such as methoxy, butoxy and phenoxy; hydrocarbylmercapto groups such as methylmercapto and phenylmercapto; hydrocarbyloxycarbonyl groups such as methoxycarbonyl and phenoxycarbonyl; hydrocarbylcarbonyl groups such as formyl, acetyl and benzoyl; hydrocarbylcarbonyloxy groups such as acetoxy and cyclohexanecarbonyloxy; hydrocarbylcarbonamido groups such as acetamido and benzamido; azo; boryl; halo groups such as chloro, bromo, iodo and fluoro; hydroxy; oxo; diphenylarsino; diphenylstilbino; trimethylgermano; trimethylsiloxy; and aromatic groups such as cyclopentadienyl, phenyl, tolyl, naphthyl, and indenyl. With the sulfonium salts, it is possible for the substituent to be further substituted with a dialkyl- or diarylsulfonium cation; an example of this would be 1,4-phenylene bis(diphenylsulfonium).

Useful onium salt photoacid generators include diazonium salts, such as aryl diazonium salts; halonium salts, such as diarlyiodonium salts; sulfonium salts, such as triarylsulfonium salts, such as triphenyl sulfonium triflate; selenonium salts, such as triarylselenonium salts; sulfoxonium salts, such as triarylsulfoxonium salts; and other miscellaneous classes of onium salts such as triaryl phosphonium and arsonium salts, and pyrylium and thiopyrylium salts.

Ionic photoacid generators include, for example, bis(4-t-butylphenyl) iodonium hexafluoroantimonate (FP5034™ from Hampford Research Inc., Stratford, CT, USA), a mixture of triarylsulfonium salts (diphenyl(4-phenylthio) phenylsulfonium hexafluoroantimonate, bis(4-(diphenylsulfonio)phenyl)sulfide hexafluoroantimonate) available as Syna PI-6976™ from Synasia, Metuchen, NJ, USA, (4-methoxyphenyl)phenyl iodonium triflate, bis(4-tert-butylphenyl) iodonium camphorsulfonate, bis(4-tert-butylphenyl) iodonium hexafluoroantimonate, bis(4-tert-butylphenyl) iodonium hexafluorophosphate, bis(4-tert-butyl phenyl) iodonium tetraphenylborate, bis(4-tert-butyl phenyl) iodonium tosylate, bis(4-tert-butylphenyl) iodonium triflate, ([4-(octyloxy)phenyl]phenyliodonium hexafluorophosphate), ([4-(octyloxy)phenyl]phenyliodonium hexafluoroantimonate), (4-isopropylphenyl)(4-methylphenyl)iodonium tetrakis(pentafluorophenyl) borate (available as Rhodorsil 2074™ from Bluestar Silicones, East Brunswick, NJ, USA), bis(4-methylphenyl) iodonium hexafluorophosphate (available as Omnicat 440 from IGM Resins, Charlotte, NC, USA), 4-(2-hydroxy-1-tetradecycloxy)phenyl]phenyl iodonium hexafluoroantimonate, triphenyl sulfonium hexafluoroantimonate (available as CT-548 from Chitec Technology Corp. Taipei, Taiwan), diphenyl(4-phenylthio)phenylsulfonium hexafluorophosphate, bis(4-(diphenylsulfonio)phenyl)sulfide bis(hexafluorophosphate), diphenyl(4-phenylthio)phenylsulfonium hexafluoroantimonate, bis(4-(diphenylsulfonio)phenyl)sulfide hexafluoroantimonate, and blends of these triarylsulfonium salts available from Synasia under the trade designations of Syna PI-6992 and Syna PI-6976 for the PF₆ and SbF₆ salts, respectively.

A preferred photoacid generator in a triaryl sulfonium hexafluoroantimonate salt obtained as a 50% solution in propylene carbonate under the designation “CPI-6976” from Aceto Corporation (Port Washington, NY, USA). This solution may be dried to yield the pure solid salt, which is also a preferred photoacid generator.

Other photoacid generators are triazine compounds having the formula.

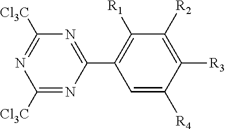

wherein R¹, R², R³ and R⁴ of this triazine crosslinking agent are independently hydrogen or alkoxy group, and 1 to 3 of R¹, R², R³ and R⁴ are hydrogen. The alkoxy groups typically have no greater than 12 carbon atoms. In favored embodiments, the alkoxy groups are independently methoxy or ethoxy. One representative species is 2,4-bis(trichloromethyl)-6-(3,4-bis(methoxy)phenyl)-triazine. Such triazine compounds are further described in U.S. Pat. No. 4,330,590.

In some embodiments, the ROMP catalyst is thermally activated; whereas the initiator for second polymerizable material is activated by exposure to actinic radiation. In one embodiment, as demonstrated in the forthcoming examples (e.g. triaryl sulfonium hexafluoroantimonate) cationic (CPI-6976) photoacid generator initiator can initiate curing of epoxy groups at lower wavelengths. In another embodiment, (e.g. ethyl (2,4,6-trimethylbenzoyl) phenylphosphinate free-radical photoinitiator (OMNIRAD TPO-L) can initiate curing of (meth)acrylate monomer(s) at higher wavelengths of light. Heat can accelerate curing reactions of the cationic photoacid generator.

Alternatively or in combination with a photoacid generator, a thermal acid generator may be utilized to initiate the epoxy polymerization. In this embodiment, the thermal acid generator typically activates at a higher or lower temperature than the temperature of thermal activation of the ROMP catalyst. For example, the cyclic olefins can be polymerized at room temperature or lower temperatures (less than 100° C.) with the ROMP catalyst and the epoxide groups cured via thermal activation (without light) at elevated temperature with use of the previously described iodonium salts.

The thermal and/or photoacid generators are typically employed at concentrations ranging from about 0.0001 to about 3.0 parts by weight, preferably from about 0.001 to about 1.0 parts by weight, and more preferably from about 0.005 to about 0.5 parts by weight of the organic portion of the total composition.

### Optional Other Components

In some embodiments, the sum of the cyclic olefin(s) and second polymerizable material is typically at least 50, 60, 70, 80, 90, 95 wt. % of the total composition. The composition typically comprises a homogeneous mixture of second polymerizable material and cyclic olefin(s).

The mixture of cyclic olefin(s) and second polymerizable material has a suitable viscosity for various methods of application. The complex viscosity is typically greater than the cyclic olefin. In some embodiments, the complex viscosity is at least 1 or 2 Pa·s at various frequencies (e.g. 200, 126.2, 79.6, 20, 5, 2, 0.8 or 0.1 rad/sec). In some embodiments, the complex viscosity is less than 15, 14, 13, 12, 11, 10, 9, 8, 7, 6, 5, 4, or 3 at various frequencies (e.g. 200, 126.2, 79.6, 20, 5, 2, 0.8 or 0.1 rad/sec). The mixture can be shear thinning. The ratio of the complex viscosity at 0.1 rad/sec divided by the complex viscosity at 200 rad/sec can be at least 2, 3, or 4 and may be less than 5.

The composition (e.g. of the article and methods) may optionally comprise other (e,g, unpolymerizable components) that may be described as additives. Additives include adhesion promoters, tackifiers, plasticizers, antioxidants, UV stabilizers, colorants and (e.g. inorganic) fillers.

When the composition further comprises other components, the sum of the cyclic olefin(s) and second polymerizable material is typically less than 90, 80, 70, 60, 50, 40, or 30 wt. % of the total composition. For example, the sum of the cyclic olefin(s) and second polymerizable material may be 50 wt. % and the composition (e.g. of the article) may comprise 50 wt. % of additive such as inorganic filler.

The composition may further comprise an adhesion promoter. Various adhesion promoters have been described in the literature. See for example, WO2021/074734 and WO2021/074749; incorporated by reference.

In some embodiments, the adhesion promoter is a compound or polymer containing at least two isocyanate groups.

Representative polymeric polyisocyanates (e.g. diisocyanate) include for example polyisocyanate prepolymers available from Covestro (Elgin, IL, USA) including the trade designations DESMODUR E-28 (MDI based) and Baytec ME-230 (modified MDI based on polytetramethylene ether glycol (PTMEG). Such polymeric polyisocyanates (e.g. diisocyanates) comprise C2-C4 alkylene oxide repeat units. Further, such polymeric polyisocyanates typically have an average equivalent weight ranging from 200-5000 g/mole per isocyanate group.

Other polymeric isocyanates include for example PM200 (poly MDI), Lupranate™ (poly MDI from BASF), various isocyanate terminated polybutadiene prepolymers available from Cray Valley including Krasol™ LBD2000 (TDI based), Krasol™ LBD3000 (TDI based), Krasol™ NN-22 (MDI based), Krasol™ NN-23 (MDI based), and Krasol™ NN-25 (MDI based).

In other embodiments, the composition may comprise a maleic anhydride grafted polymer as an adhesion promoter such as available under the trade designation “POLYVEST MA 75” from Evonik, Essen, Germany and under the trade designation “RICON 131 Maleinized Polybutadiene 131MA10” from Cray Valley, Exton, PA or from Kraton Performance Polymers as the trade designations “Kraton FG1901G” and “Kraton FG1924G”.

In yet other embodiments, the composition may comprise a compound or polymer with alkoxy silane groups as an adhesion promoter. Several trialkoxysilane compounds can be obtained from Gelest (Morrisville, PA, USA) such as 3-(trimethoxysilyl)propyl methacrylate obtained as “A174” from Alfa Aesar (Ward Hill, MA, USA). A trimethoxysilane-terminated polybutadiene oligomer can be obtained as “STM” from Evonik (Essen, Germany).

When present, the composition typically comprises at least 0.005, 0.010, 0.050, 0.10, 0.50, or 1 wt. % of adhesion promoter based on the total weight of the composition. In some embodiments, the amount of adhesion promoter is no greater than 10, 9, 8, 7, 6, 5, 4, 3, 2, or 1 wt. % of the total weight of the composition.

In some embodiments, the composition further comprises inorganic fillers, including for example silica (e.g. fumed silica, glass bubbles), metal oxides, hydroxides, oxyhydroxides, silicates, borides, carbides, and nitrides.

In some embodiments, the composition of the (e.g. electronic) article comprises thermally conductive inorganic particles are preferably an electrically non-conductive material, as described in WO2021/074734; incorporated herein by reference. Suitable electrically non-conductive, thermally conductive materials include ceramics such as metal oxides, hydroxides, oxyhydroxides, silicates, borides, carbides, and nitrides. Suitable ceramic fillers include, e.g., silicon oxide, zinc oxide, alumina trihydrate (ATH) (also known as hydrated alumina, aluminum oxide, and aluminum trihydroxide), aluminum nitride, boron nitride, silicon carbide, and beryllium oxide. Other thermally conducting fillers include carbon-based materials such as graphite and metals such as aluminum and copper. Combinations of different thermally conductive materials may be utilized. Such materials are not electrically conductive, i.e. have an electronic band gap greater than 0 eV and in some embodiments, at least 1, 2, 3, 4, or 5 eV. In some embodiments, such materials have an electronic band gap no greater than 15 or 20 eV.

Thermally conductive particles are available in numerous shapes, e.g. spheres and acicular shapes that may be irregular or platelike. In some embodiments, the thermally conductive particles are crystals, typically have a geometric shape. For example, boron nitride hexagonal crystals are commercially available from Momentive. Further, alumina trihydrate is described as a hexagonal platelet. Combinations of particles with different shapes may be utilized. The thermally conductive particles generally have an aspect ratio less than 100:1, 75:1, or 50:1. In some embodiment, the thermally conductive particles have an aspect ratio less than 3:1, 2.5:1, 2:1, or 1.5:1. In some embodiments, generally symmetrical (e.g., spherical, semi-spherical) particles may be employed.

In some embodiments, the thermally conductive particles comprise a combination of smaller particles and larger particles. The combination of particle sizes can provide higher thermal conductivity, than thermally conductive particles having an intermediate median particle size and a normal particle size distribution. Without intending to be bound by theory it is surmised that including a sufficient amount of smaller particles of the proper particle size improves the thermal conductivity between the larger particles.

The compositions of the abrasive article comprise abrasive particles. Suitable abrasive particles may comprise any abrasive particle used in the abrasives industry. Preferably, the abrasive particles have a Mohs hardness of 8.5 or greater, more preferably 9 or greater, and most preferably 9-10. In certain embodiments, the abrasive particles comprise superabrasive particles. As used herein, the term “superabrasive” refers to any abrasive particle having a hardness greater than or equal to that of silicon carbide (e.g., silicon carbide, boron carbide, cubic boron nitride, and diamond).

Typically, the abrasive particles comprise at least one of diamond particles, metal oxide ceramic particles, or non-oxide ceramic particles. Examples of suitable abrasive particles include for instance and without limitation, cubic boron nitride, fused aluminum oxide, ceramic aluminum oxide, heat treated aluminum oxide, white fused aluminum oxide, black silicon carbide, green silicon carbide, titanium diboride, boron carbide, silicon nitride, tungsten carbide, titanium carbide, diamond, cubic boron nitride, hexagonal boron nitride, alumina, zirconia, iron oxide, ceria, garnet, fused alumina zirconia, alumina-based sol gel derived abrasive particles and the like. The alumina abrasive particle may contain a metal oxide modifier. The diamond and cubic boron nitride abrasive particles may be mono crystalline or polycrystalline. Other examples of suitable inorganic abrasive particles include silica, iron oxide, chromia, ceria, zirconia, titania, tin oxide, gamma, alumina, and the like.

The abrasive particles may comprise abrasive agglomerate particles. Abrasive agglomerate particles typically comprise a plurality of abrasive particles, a binder, and optional additives. The binder may be organic and/or inorganic. Abrasive agglomerates may be randomly shape or have a predetermined shape associated with them. Optionally, abrasive agglomerates comprise ceramic abrasive agglomerates that comprise individual abrasive particles dispersed in a porous ceramic matrix, in which at least a portion of the porous ceramic matrix comprises glassy ceramic material

In some embodiments, the abrasive particles may comprise at least one of cubic boron nitride, silicon carbide, titanium diboride, titanium nitride, boron carbide, tungsten carbide, titanium carbide, aluminum nitride, aluminum oxide, diamond, garnet, fused alumina-zirconia, sol-gel derived abrasive particles, cerium oxide, zirconium oxide, titanium oxide, silicon dioxide, or silicon nitride particles.

Various abrasive particles are described in the literature. See for example WO2022/101746; incorporated herein by reference.

When present, the composition typically comprises at least 10, 15, 20, 25, 30, 35, 40, 45 or 50 wt. % of inorganic filler based on the total weight of the composition. In some embodiments, the amount of inorganic filler is no greater than 70, 65, 60, 55, 50, 45, 40, 35, 30, 25, 20, 15, or 10 wt. % of the total weight of the composition.

### Descriptions of Substrates and Articles

Various articles can be formed from the composition including electronic articles, abrasive articles, and components thereof.

In some embodiments, the article is a two-layer article that comprise a layer of the composition disposed on a substrate. The composition typically has a thickness of at least 1, 2, 3, 4, or 5 microns. In some embodiments, the composition has a thickness no greater than 10 mils, 5 mils, 1 mil (1000 microns), 500, 250, 100 or 50 microns.

Useful substrates can be inorganic, organic, or combinations thereof. Representative examples of useful substrates include ceramics, siliceous substrates including glass, metal (e.g., aluminum or steel), natural and man-made stone, woven and nonwoven articles, polymeric materials, including thermoplastic and thermosets, (such as polymethyl (meth)acrylate, polycarbonate, polystyrene, styrene copolymers, such as styrene acrylonitrile copolymers, polyesters, polyethylene terephthalate), and composites of the foregoing materials.

In some embodiments, the substrate is a film or a (e.g., PET) release liner. In this embodiment, the article may be a transfer tape or transfer film.

Due to the low Dk values, the compositions are suitable for use as structural adhesive, insulating layer, or protective layer including encapsulant of an electronic telecommunication article such as printed circuit boards, integrated circuits, antennas, and optical cable.

Abrasive articles generally comprise a plurality of abrasive particles and a binder. Many different types of abrasive articles are available. Among these are: (1) coated abrasive articles, in which a binder make coat bonds the abrasive particles to a backing material (e.g., “sandpaper”); (2) lapping coated abrasive articles, in which the abrasive particles are dispersed in a binder to form an abrasive composite, which is bonded to a backing to form an abrasive article; (3) three-dimensional shaped composite abrasive articles, in which the abrasive particles are dispersed in a binder to form a plurality of abrasive composites, which are bonded to a backing to form an abrasive article; (4) bonded abrasive articles, in which the binder bonds the particles together to form a shaped mass, e.g., a grinding wheel or brush; and (5) nonwoven abrasive articles, in which the binder bonds the abrasive particles onto the fibers of a nonwoven fibrous substrate in either a make coat or dispersed format. Various abrasive article backing substrates can be used, e.g., cloth, film, foil, paper, fibrous material, polymeric film, and the like.

### Methods of Making Articles

Presently described are method of making articles comprising
A) applying a composition, as described herein, to a substrate; B) polymerizing the cyclic olefins; and
C) curing the second polymerizable material.

The compositions (e.g. of the articles and method) are typically polymerized/cured in two separate steps. In one step, the cyclic olefins are at least partially polymerized/cured via ROMP when the composition is heated and/or allowed to sit at room temperature. In another step, the second polymerizable material may be polymerized via free-radical polymerization (in the case of (meth)acrylic components). In the case of epoxy components, the second polymerizable material may be polymerized via cationic polymerization. In some embodiments, the composition is irradiated with an external UV light sufficient to activate the free-radical photoinitiator and/or photoacid generator.

The heat source for the heating step may be an oven, a flame, a hot plate, or any other heat source. The heating step may be carried out at at least 40, 50, 60, 70, 80, 90, 100, 110 or 120° C. The heating step may last at least 1, 2, 3, 4, 5, 10, 30, 60, or 120 minutes. The light source for the irradiation step may be an actinic light source (e.g., at least one of a blue light source or a UV light source). UV light sources can be of two types: 1) relatively low light intensity sources such as blacklights which provide generally 10 mW/cm2 or less (as measured in accordance with procedures approved by the United States National Institute of Standards and Technology as, for example, with a Uvimap™ UM 365 L-S radiometer manufactured by Electronic Instrumentation & Technology, Inc., Sterling, VA, USA) over a wavelength range of 280 to 400 nanometers and 2) relatively high light intensity sources such as medium pressure mercury lamps which provide intensities generally greater than 10 mW/cm2, preferably between 15 and 450 mW/cm2. The irradiation step may last at least 5, 10, 15, 30, or 60 seconds; or at least 2, 3, 4, 5, 10, or 30 minutes.

The compositions described herein may be cured via a variety of methods. In some embodiments, step B occurs prior to step A. In other embodiments, step A occurs prior to step B. In some embodiments, the curing method comprises first subjecting the composition to a heating step, and subsequently to an irradiation step. In other embodiments, the curing method comprises first subjecting the composition to an irradiation step, and subsequently to a heating step. In still other embodiments, the curing method comprises subjecting the composition to simultaneous heating and irradiation steps. In still other embodiments, the curing method comprises allowing the composition to sit at ambient conditions for a period of time (this serves as a “heating step” using only ambient heat) and subsequently subjecting the composition to an irradiation step.

The articles described herein may be reaction products of compositions that have been subjected to any of the above curing methods. The articles described herein may also be compositions that have been subjected to none or some of the steps of the curing methods described above. In some embodiments, the (e.g. structural adhesive or transfer tape) article comprises the reaction product of a composition wherein the cyclic olefins or second polymerizable material are at least partially cured. The term “partially cured” signifies that some of the active polymerizable groups (e.g. cyclic olefins, (meth)acrylates, epoxies) in the composition have been polymerized while some have not been polymerized.

In some embodiments, a film or release liner is provided comprising a layer of the composition described herein wherein the cyclic olefin is at least partially cured and the second polymerizable material is uncured. In another embodiments, a film or release liner is provided comprising a layer of the composition described herein, wherein in the cyclic olefin is uncured and the second polymerizable material is at least partially cured.

When both the cyclic olefin(s) and second polymerizable material(s) are fully cured, the cured composition is typically a hard solid. In some embodiments, the Shore A Hardness is greater than 30, 40, or 50 and may range up to 75, 80, 85 or greater. The Shore A Hardness of the partially cured composition can be less than 30 or 25 and is typically at least 5, 10 or 15.

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

### EXAMPLES

Unless otherwise noted, all parts, percentages, ratios, etc. in the Examples and the rest of the specification are by weight. Unless otherwise indicated, all other reagents were obtained, or are available from fine chemical vendors such as MilliporeSigma, (Burlington, MA, USA) or may be synthesized by known methods. Table 1 (below) lists materials used in the examples and their sources.

TABLE 1
Materials List

| | DESCRIPTION | SOURCE |
|---|---|---|
| A174 | 3-(Trimethoxysilyl)propyl methacrylate obtained as | Alfa Aesar [Ward |
| | “A174” | Hill, MA, USA] |
| BD605E | OH-terminated linear epoxidized polybutadiene obtained as | Cray Valley |
| | “POLY BD 605E” | [Exton, PA, USA] |
| BDK | UV-activated radical initiator, obtained as “OMNIRAD | IGM Resins |
| | 651” | [Charlotte, NC, |
| | | USA] |
| CT762 | Olefin metathesis catalyst (1% in mineral oil) obtained as | Materia, Inc. |
| | “PROXIMA CT-762” | [Pasadena, CA, |
| | | USA] |
| 3MDA | Diamond agglomerates synthesized as described in | 3M [St. Paul, MN, |
| | U.S. Pat. No. 6,551,366. | USA] |
| ERL4221 | Cycloaliphatic epoxy resin obtained as “ERL 4221”. | Polysciences, Inc |
| | | [Warrington, PA, |
| | | USA] |
| EXP1970 | Cyclic olefin resin obtained as “PROXIMA EXP 1970” | Materia, Inc. |
| HPR2029 | Cyclic olefin resin obtained as “PROXIMA HPR 2029” | Materia, Inc. |
| HPR2128 | Cyclic olefin resin obtained as “PROXIMA HPR 2128” | Materia, Inc. |
| OM184 | Iodonium salt cationic photoinitiator obtained as | IGM Resins |
| | “OMNIRAD 184” | |
| SR368D | Tris[(2-acryloyloxy)ethyl]isocyanurate obtained as | IGM Resins |
| | “SR368D” | |
| SR833S | Tricyclodecanedimethanol Diacrylate, obtained as | Sartomer [Exton, |
| | “SR833S” | PA, USA] |
| STM | Trimethoxysilane-terminated polybutadiene, obtained as | Evonik [Essen, |
| | “STM” | Germany] |
| TASHFA | Triaryl sulfonium hexafluoroantimonate cationic | 3M |
| | photoinitiator obtained as “CPI-6976” from Aceto | |
| | Corporation (Port Washington, NY, USA) and dried of | |
| | propylene carbonate solvent under vacuum. | |
| TPOL | Free-radical photoinitiatior obtained as “OMNIRAD TPO- | IGM Resins |
| | L” | |
| ULTRENE | Cyclic olefin resin, obtained as “ULTRENE 99-6 DCPD” | Cymetech, Inc. |
| | | [Calvert City, KY, |
| | | USA] |

### Test Methods

### Hardness

A Shore A Hardness tester (Model #408 from PTC Instruments, Los Angeles, CA, USA) was utilized to measure hardness on the solidified materials. The tester had a truncated cone tip with a 35-degree included angle and a force of 821 grams-force. The result was an average of 3 readings and the procedure was in accordance with ASTM D2240.

### Dielectric Properties

Dielectric properties were measured at 23° C. and 35% relative humidity. The sample dimensions were: 30 mm×50 mm with a maximum thickness of 0.85 mm. All split-post dielectric resonator measurements were performed in accordance with the standard IEC 61189-2-721, at the individual frequencies. Each material was inserted between two fixed dielectric resonators. The resonance frequency and quality factor of the posts are influenced by the presence of the specimen, and this enables the direct computation of complex permittivity (dielectric constant and dielectric loss). The geometry of the split dielectric resonator fixture used in our measurements was designed by the Company QWED (Warsaw, Poland). These resonators operate with the TE01d mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This Split Post Resonator measurement system was combined with Keysight VNA (Vector Network Analyzer Model PNA N5222B along with millimeter-wave test set model N5292A, 900 Hz-110 GHz). Computations were performed with the commercial analysis Split Post Resonator Software of QWED to provide a powerful measurement tool for the determination of complex electric permittivity of each specimen at the specific frequency. Error analysis came from QWED. eps' error is calculated from the equation (+/−(0.0015+Δh/h)*ε); tan delta error is 3% of the tan delta measured.

### Rheological Properties

A Model DHR-3 (TA Instruments, New Castle, DE, USA) rheometer fitted with a Peltier plate temperature control accessory and a 25 mm geometry (TA Instruments SMART SWAP fixture) without a solvent trap well was used to measure complex viscosity. All of the above are available from TA Instruments (New Castle, DE, USA). The same rheometer with a Peltier plate assembly was utilized to measure complex viscosity. Measurements were done at room temperature using a frequency sweep mode (frequency range).

### Examples EX-1 to EX-7: ROMP-Acrylate Interpenetrating Networks

In 20-mL screw-capped glass vials, the components shown on Table 2 were combined and shaken such that the solids dissolved.

TABLE 2
Compositions of EX-1 to EX-7

| | ULTRENE, g | SR833S, g | BDK, g | CT762, g |
|---|---|---|---|---|
| Example | (wt %) | (wt %) | (wt %) | (wt %) |
| EX-1 | 1.49 (49.5) | 1.49 (49.5) | 0.030 (1.0) | — |
| EX-2 | 1.49 (49.5) | 1.49 (49.5) | — | 0.030 (1.0) |
| EX-3 | 1.47 (49.0) | 1.47 (49.0) | 0.030 (1.0) | 0.030 (1.0) |
| EX-4* | 2.25 (75.1) | 0.74 (24.7) | 0.008 (0.3) | — |
| EX-5* | 1.80 (60.0) | 1.19 (39.6) | 0.012 (0.4) | — |
| EX-6* | 1.50 (49.9) | 1.49 (49.6) | 0.015 (0.5) | — |
| EX-7* | 0.90 (30.0) | 2.08 (69.3) | 0.021 (0.7) | — |

Each of the compositions in Table 2 was irradiated in its vial by placing the vial in the chamber of a 36-Watt UV Nail Lamp (NailStar Professional, London, England) for 30 seconds (s) with the lamp turned on. The appearance of the compositions was recorded after this irradiation step (see Table 3 below). Following the irradiation, EX-1, EX-2, and EX-3 were placed in an oven at 120° C. for 20 minutes. The appearance of these compositions was also recorded in Table 3.

TABLE 3
Results of Curing Studies for EX-1 to EX-7

| | | Appearance after Irradiation + |
|---|---|---|
| Example | Appearance after Irradiation | Heating |
| EX-1 | Soft Gel | Soft Gel |
| EX-2 | Liquid | Soft Gel |
| EX-3 | Soft Gel | Hard Solid |
| EX-4 | Liquid | — |
| EX-5 | Soft Gel | — |
| EX-6 | Soft Gel | — |
| EX-7 | Soft Gel | — |

*EX-4 to EX-7 are intermediate compositions since they lack a ROMP catalyst (e.g., CT762). However, their curing behavior (see Table 3) shows that a minimum concentration of acrylate monomer (e.g., SR833S) is needed for the composition to form a solid upon ultraviolet (UV) irradiation. These examples would be expected to behave similarly to EX-3 upon heating (i.e., further curing/hardening) if they contained a similar amount of ROMP catalyst.

### Examples EX-8 to EX-9: ROMP-Acrylate Interpenetrating Networks

Stock Solution 1 was made by mixing 97 parts by weight (pbw) HPR2029, 1 pbw CT762, and 2 pbw STM in a polypropylene speedmixer cup and mixing at 3500 revolutions per minute (rpm) for 15 s in a high shear mixer (SpeedMixer DAC 150.1 FVZ-k, (Hauschild & Co. KG, Hamm, Germany)).

Stock Solution 2 was made by mixing 96 pbw SR368D, 1 pbw TPO-L, and 3 pbw A-174 in a speedmixer cup and mixing at 3500 rpm for 15 s.

Stock Solution 3 was made by combining 30 pbw Stock Solution 1 and 70 pbw Stock Solution 2 in a speedmixer cup and mixing at 3500 rpm for 15 s.

Stock Solution 4 was made by combining 70 pbw Stock Solution 1 and 30 pbw Stock Solution 2 in a speedmixer cup and mixing at 3500 rpm for 15 s.

EX-8 was made by combining 55 pbw Stock Solution 3 with 45 pbw 3MDA in a speedmixer cup and mixing at 3500 rpm for 15 s.

EX-9 was made by combining 55 pbw Stock Solution 4 with 45 pbw 3MDA in a speedmixer cup and mixing at 3500 rpm for 15 s.

The overall compositions of EX-8 and EX-9 are shown in Table 4

TABLE 4
Compositions of EX-8 and EX-9

| Example | HPR2029, pbw | SR368D, pbw | 3MDA, pbw | CT762, pbw | TPO-L, pbw | STM, pbw | A174, pbw |
|---|---|---|---|---|---|---|---|
| EX-8 | 16.01 | 36.96 | 45.00 | 0.17 | 0.39 | 0.33 | 1.16 |
| EX-9 | 37.35 | 15.84 | 45.00 | 0.39 | 0.17 | 0.77 | 0.50 |

EX-8 and EX-9 were slurries directly after mixing. The slurries were each coated onto a microreplicated polypropylene tool (as described in U.S. Pat. No. 6,923,840, Column 19, Lines 19-24.) An 8-mil (0.2 mm) ESTANE 58887 polyurethane backing film (Lubrizol, Brecksville, OH, USA) was added to cover the slurries in the tool. A tongue depressor was used to spread the slurries under the polyurethane backing to remove excess resin. The sandwiched layers were then put in between 2 glass plates and irradiated with UV by being exposed to two passes at 20 feet per minute (0.1 meters per second) from a FUSION LIGHT HAMMER 10 equipped with a D bulb (Heraeus Noblelight America, Gaithersburg, MD, USA) set at 100% intensity. The sandwich constructions were taken apart and the EX-8 and EX-9 materials were inspected. The EX-8 material was easily removable as a freestanding film that had microreplicated features on its surface. The EX-9 material did not easily separate from the polypropylene tool as some uncured, liquid monomer remained.

### Examples EX-10 to EX-13: ROMP-Epoxy Interpenetrating Networks

The compositions shown in Table 5 were combined in glass jars and hand-mixed with tongue depressors. In each case, two pre-mixtures were made in glass jars and hand-mixed with tongue depressors (each dissolving a catalyst in one resin component) and then combined and similarly mixed to obtain the Example compositions.

EX-10 was made by combining the entireties of Pre-Mixture 10A and Pre-Mixture 10B.

EX-11 was made by combining the entireties of Pre-Mixture 11A and Pre-Mixture 11B.

EX-12 was made by combining 4 g of Pre-Mixture 12A with 6 g of Pre-Mixture 12B.

EX-13 was made by combining 8 g of Premixture 13A with 12 g of Pre-Mixture 13B.

The final overall compositions are shown in Table 5.

TABLE 5
Compositions of EX-10 to EX-13

| | | EXP1970, g | BD605E, g | ERL4221, g | CT762, g | TASHFA, g | OM184, g |
|---|---|---|---|---|---|---|---|
| Example | HPR2128, g | (wt %) | (wt %) | (wt %) | (wt %) | (wt %) | (wt %) |
| Pre-Mixture 10A | | 4.00 (99.5) | | | 0.02 (0.5) | | |
| Pre-Mixture 10B | | | 6.00 (99.5) | | | 0.03 (0.5) | |
| EX-10 | | 4.00 (39.8) | 6.00 (59.7) | | 0.02 (0.2) | 0.03 (0.3) | |
| Pre-Mixture 11A | | 4.00 (99.5) | | | 0.02 (0.5) | | |
| Pre-Mixture 11B | | | | 5.90 (99.5) | | | 0.03 (0.5) |
| EX-11 | | 4.00 (40.2) | | 5.90 (59.3) | 0.02 (0.2) | | 0.03 (0.3) |
| Pre-Mixture 12A | 5.00 (99.0) | | | | 0.05 (1.0) | | |
| Pre-Mixture 12B | | | 6.25 (99.7) | | | 0.02 (0.3) | |
| EX-12 | 3.96 (39.6) | | 5.98 (59.8) | | 0.04 (0.4) | 0.02 (0.2) | |
| Pre-Mixture 13A | 10.00 (99.0) | | | | 0.10 (1.0) | | |
| Pre-Mixture 13B | | | 12.00 (99.1) | | | | 0.11 (0.9) |
| EX-13 | 7.92 (39.6) | | 11.89 (59.5) | | 0.08 (0.4) | | 0.11 (0.6) |

In all instances below, UV irradiation was done using a BLK-Ray Model XX-15L 150V, 60 Hz, 0.68 A lamp (UVP, San Gabriel, CA, USA). The bulb in the lamp was a 350 nm Blacklight Bulb F15T8/BLB 15 W (OSRAM Sylvania, Wilmington, MA, USA). The light source was placed at a distance of 1 inch (2.54 cm) from the sample composition.

Approximately 3 grams each of freshly prepared EX-10 and EX-11 were separately deposited on a silicone-treated polyethylene terephthalate (PET) release liner. These samples were irradiated for 1 hour, after which time neither had gelled or solidified. The samples were then heated for 16 h in an oven at 80° C., after which time EX-10 had hardened to a homogeneous solid and EX-11 had changed into a white solid with liquid on top. Separately, a ˜3-gram sample of EX-10 was allowed to sit at room temperature for 5 days, after which time it was irradiated for 5 minutes. This treatment resulted in a hard homogeneous solid.

Approximately 1 gram of Pre-Mixture 12A was deposited on a PET release liner and irradiated for 30 minutes, after which time it had become a stringy liquid. The stringy liquid was heated for 1 h in the oven at 80° C., after which time it was a hard solid. Separately, two ˜3-gram samples of EX-12 were placed on PET release liners. The first of these was irradiated for 30 minutes and subsequently heated in an oven at 80° C. for 2 hours, after which it was a white solid that measured 72 Shore A hardness. The second of these was heated in an oven at 80° C. for 30 minutes and subsequently irradiated for 15 minutes, after which it was a brown solid with dark spots that measured 24 Shore A hardness.

Approximately half of EX-13 was placed between glass slides using 0.4-mm-thick polytetrafluoroethylene (PTFE) spacers. The other half of EX-13 was deposited onto a PET release liner. Both halves were heated in an oven at 80° C. for 1 hour and subsequently irradiated for 15 minutes. The sample between glass slides was flipped over and irradiated on the other side for an additional 15 minutes (30 minutes total irradiation). Measurements of the dielectric properties of the sample cured between glass slides were carried out according to the General Procedure. Separately, another batch of EX-13 was made according to the component amounts on Table 5 and split into several portions in small aluminum pans. One such portion of EX-13 was heated in an oven at 80° C. for 30 minutes and subsequently irradiated for 15 minutes. Another such portion of EX-13 was irradiated for 15 minutes and subsequently heated in an oven at 80° C. for 30 minutes. A third such portion of EX-13 was heated on a hot plate at 80° C. for 15 minutes while simultaneously being irradiated for that time. Separately, small portions (˜0.1 g) of Pre Mixture 13A and Pre-Mixture 13B were placed in aluminum pans. The small portion of Pre-Mixture 13A was irradiated for 30 minutes. The small portion of Premixture 13B was irradiated for 30 minutes and subsequently heated in an oven at 80° C. for 30 minutes.

The cure conditions, measured hardness, and measured dielectric properties of all portions of EX-10 to EX-13 (and the associated Pre-Mixtures) are shown in Table 6. Hardness and dielectric measurements were taken after all steps of the Treatment and Cure Conditions were completed.

TABLE 6
Cure Conditions and Results for EX-10 to EX-13

| | | | | Dk |
|---|---|---|---|---|
| | | | | Dielectric Loss |
| | | | Hardness, | Tan(delta) at |
| | Treatment and Cure Conditions | Appearance | Shore A | 10.1 GHz |
| EX-10 | 1) UV irradiation for 1 hour | Liquid after Step 1, | — | — |
| | 2) 80° C. for 16 hours | hard solid after Step 2 | | |
| EX-10 | 1) Room temperature for 5 days | Liquid after Step 1, | — | — |
| | 2) UV irradiation for 5 minutes | hard solid after Step 2 | | |
| EX-11 | 1) UV irradiation for 1 hour | Liquid after Step 1, | — | — |
| | 2) 80° C. for 16 hours | about 70% white solid | | |
| | | with about 30% liquid | | |
| | | on top after Step 2 | | |
| EX-12 | 1) UV irradiation for 30 minutes | White solid after Step 2 | 72 | — |
| | 2) 80° C. for 2 hours | | | |
| EX-12 | 1) 80° C. for 30 minutes | Brown solid with dark | 24 | |
| | 2) UV irradiation for 15 minutes | spots after Step 2. | | |
| Pre- | 1) UV irradiation for 30 minutes | Stringy liquid after | — | — |
| Mixture | 2) 80° C. for 1 hour | Step 1, hard solid after | | |
| 12A | | Step 2 | | |
| EX-13 | 1) Placed between glass slides (0.4 | — | | 2.48 |
| | mm spacers) | | | 0.02468 |
| | 2) 80° C. for 1 hour | | | 0.00995 |
| | 3) UV irradiation for 15 minutes | | | |
| | on each side | | | |
| EX-13 | 1) Deposited onto a PET release | Solid after Step 2. | | |
| | liner | | | |
| | 2) 80° C. for 1 hour | | | |
| | 3) UV irradiation for 15 minutes | | | |
| | 4) UV irradiation for 15 minutes | | | |
| | on other side | | | |
| EX-13 | 1) 80° C. for 30 minutes | — | 70 | |
| | 2) UV irradiation for 15 minutes | | | |
| EX-13 | 1) UV irradiation for 15 minutes | — | 65 | |
| | 2) 80° C. for 30 minutes | | | |
| EX-13 | 1) Simultaneous UV irradiation | — | 30 | |
| | and heating on hot plate at 80° C. | | | |
| Pre- | 1) UV irradiation for 30 minutes | — | 80 | |
| Mixture | | | | |
| 13A | | | | |
| Pre- | 1) UV irradiation for 30 minutes | — | 85 | |
| Mixture | 2) 80° C. for 30 minutes | | | |
| 13B | | | | |

TABLE 7
Rheological Measurements

| | BD605E | EX-13 | HPR2128 |
|---|---|---|---|
| Angular | Complex | Complex | Complex |
| frequency | Viscosity | Viscosity | Viscosity |
| (rad/sec) | (Pa · s) | (Pa · s) | (Pa · s) |
| 200 | 13.5 | 2.5 | 1.2 |
| 126.2 | 13.6 | 2.5 | 0.9 |
| 79.6 | 13.6 | 2.7 | 0.7 |
| 20 | 13.5 | 3.1 | 0.7 |
| 5 | 13.5 | 3.8 | 0.6 |
| 2 | 13.6 | 4.7 | 0.5 |
| 0.8 | 13.4 | 5.2 | 0.4 |
| 0.1 | 14.7 | 11.1 | 2 |

1. An article comprising a composition disposed on a substrate wherein the composition comprises:
i) cyclic olefin(s);
ii) a ring opening metathesis polymerization catalyst;
iii) a second polymerizable material selected from the group consisting of:
a) epoxide-containing component(s); and
b) (meth)acrylate monomer(s) comprising a cycloaliphatic or heterocycloaliphatic group;
iv) an initiator for the second polymerizable material;
wherein the composition comprises greater than 25 wt. % i) and greater than 25 wt. % of at least one of a) or b) based on the total of i) and iii); and
wherein the cyclic olefins and/or second polymerizable material are at least partially cured.

2. The article of claim 1 wherein iv) is selected such that the second polymerizable material cures at different curing conditions than the cyclic olefins.

3. The article of claim 2 wherein iv) is a photoacid generator or a free-radical photoinitiator.

4. The article of claim 1 wherein a) has a Tg less than 25, 0 or −25° C.

5. The article of claim 4 wherein a) comprises polybutadiene.

6. The article of claim 4 wherein the composition comprises a hydroxyl-containing group.

7. The article of claim 4 wherein a) further comprises ethylenically unsaturated moieties.

8. The article of claim 1 wherein b) has a Tg greater than 25, 50, 75, 100, 125, 150, or 175° C.

9. The article of claim 1 wherein b) comprises an isocyanurate group and/or a cyclic group comprising greater than 6 carbon atoms and/or comprises at least three (meth)acrylate groups.

10-11. (canceled)

12. The article of claim 1 wherein the composition further comprises inorganic filler.

13. The article of claim 1 wherein the reaction product of i) and ii) is an interpenetrating network

14. The article of claim 1 wherein in the cyclic olefin is at least partially cured and the second polymerizable material is uncured or the cyclic olefin is uncured and the second polymerizable material is at least partially cured.

15. (canceled)

16. The article of claim 14 wherein the substrate is a film or a release liner.

17. The article of claim 1 wherein the cyclic olefins and second polymerizable material are both cured.

18. The article of claim 17 wherein the article is an electronic article or an abrasive article.

19. (canceled)

20. A method of making an article comprising:
A) applying a composition to a substrate wherein the composition comprises
i) cyclic olefin(s);
ii) a ring opening metathesis polymerization catalyst;
iii) a second polymerizable material selected from the group consisting of:
a) epoxide-containing component(s); and
b) (meth)acrylate monomer(s) comprising a cycloaliphatic or heterocycloaliphatic group;
iv) an initiator for the second polymerizable material;
wherein the composition comprises greater than 25 wt. % of i) and greater than 25 wt. % of at least one of a) or b) based on the total of i) and iii);
B) polymerizing the cyclic olefins; and
C) curing the second polymerizable material.

21-22. (canceled)

23. The method of claim 20 wherein the method comprises curing the second polymerizable material by exposing the composition to actinic (e.g. ultraviolet) radiation.

24-25. (canceled)

26. A polymerizable composition comprising:
i) cyclic olefin(s);
ii) a ring opening metathesis polymerization catalyst;
iii) a second polymerizable material selected from the group consisting of:
a) epoxy monomers; and
b) (meth)acrylate monomers comprising a cycloaliphatic or heterocycloaliphatic group;
iv) an initiator for the second polymerizable material;
wherein the composition comprises greater than 25 wt. % of i) and greater than 25 wt. % of at least one of a) or b) and the sum of i) and iii) is at least 60 wt. % of the total composition.

27. A polymerizable composition comprising:
i) cyclic olefin(s);
ii) a ring opening metathesis polymerization catalyst;
iii) a second polymerizable material selected from the group consisting of:
a) epoxide-containing component(s); and
b) (meth)acrylate monomer(s) comprising a heterocycloaliphatic group;
iv) an initiator for the second polymerizable material;
wherein the composition comprises greater than 25 wt. % of i) and greater than 25 wt. % of at least one of a) or b) based on the total of i) and iii).

28. (canceled)

29. The polymerizable composition of claim 26 wherein a mixture of the cyclic olefin(s) and second polymerizable material has a ratio of a first complex viscosity at 0.1 rad/sec divided by a complex viscosity at 200 rad/sec of at least 2, 3, or 4.
